(19) United States
(12) Patent Application Publication
(10) Pub. No.: US 2006/0129474 A1
(43) Pub. Date: Jun. 15, 2006

(54) Electronic trading system

(76) Inventor: Brian Vincent Kelly, London (GB)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 11/259,373

(22) Filed: Oct. 26, 2005

(30) Foreign Application Priority Data
Oct. 26, 2004 (GB) 0423742.6

(51) Int. Cl. G06Q 40/00

(52) U.S. Cl. 705/37

(57) ABSTRACT

A client for trading on an electronic exchange is disclosed. The client has a graphical user interface (GUI) that includes the following components. a) A price region comprising a plurality of cells arranged along a locus within each of which a price can be displayed; b) An order region adjacent to the price region. The order region has a plurality of cells within which order data can be displayed. Each cell in the order region corresponds to a respective cell in the price region. c) A current price indicator that indicates a fixed point on the locus. The display is updated automatically and periodically by moving the content of the cells along the locus to maintain the current price of the market in place at the current price indicator.

### BACKGROUND TO THE INVENTION

1. Field of the Invention

This invention relates to an electronic trading system. In particular, it relates to a system for trading commodities, for example, futures, options, shares, currencies, stocks, bonds and so forth.

An increasing number of markets have been converted from a manual system of trading, in which traders operate from a market trading floor, to an electronic system of trading in which traders operate from remotely connected computers. Such electronic markets operate trading host computers, which actually perform the trading function. The traders interact with the hosts by means of client computers, connected to the host by a local area and/or wide area network link. The host computer executes software that allows a trader to be appraised of the status of the market and to perform trading activities.

Clearly, it is of particular importance that information relating to the market is provided to the trader in a clear and timely manner. This is essential as it allows the trader to buy and sell commodities at a desired price. In a market that is prone to rapid changes in price, this presents a considerable technical challenge. 2. Summary of the Prior Art

WO-A-01/65403 discloses an electronic trading client that has graphical user interface software capable of providing a display of market depth information on a client computer. This presents a display computer that includes a column of prices of a commodity in a market. Adjacent to the price column are Bid and Ask columns in which figures are displayed that represent unfilled orders in the market (the volume being bid for/offered to in the market) adjacent to these are order status columns and the trader's own bids or offers. The values in the price column do not normally change position other that in response to a user input or to the state of the market. The Bid and Ask columns move up and down as the market price changes. Therefore, the position in the price column that indicates the instantaneous market value (where the Bid and Ask column meet) also changes.

This can be problematic for a trader. A trader uses a pointer such as a mouse to initiate a trading action by clicking at a point on the screen indicative of a desired trading value. In a rapidly changing market, the position of the current market value may move up and down rapidly, forcing a trader to chase it. It is also possible that the position of the current market value will change in the time between a trader pointing at it and clicking a mouse button to initiate the trade. Moreover, the market value may move so much that the value moves out of the range of the displayed prices column. The trader must then manually initiate a re-centring of the prices column, which is a distracting and could potentially result in a trading opportunity being missed.

### SUMMARY OF THE INVETION

An aim of this invention is to provide a client for an electronic trading system that is capable of providing a trader with an improved display representative of market depth.

From a first aspect, this invention provides a client for trading on an electronic exchange, the client having a graphical user interface (GUI) that includes:
a price region comprising a plurality of cells arranged along a locus a within each of which a price can be displayed;
an order region adjacent to the price region, the order region having a plurality of cells within which order data can be displayed, each cell in the order region corresponding to a respective cell in the price region; and characterised by
a current price indicator that indicates a fixed point on the locus;
and in that the display is updated by moving the content of the cells along the locus to maintain the current price of the market in place at the current price indicator.

Thus, the price region and the order region effectively scroll automatically in response to changes in the market in increments of one or more cells when the current market trading price changes such that the current price can always be found at the same location on the locus.

The display may be updated automatically by the client. Updating typically takes place without any requirement for an action by a user. For example, it may take place periodically or in response to a change in the market.

In a typical embodiment, the locus is a straight line that may be vertical or horizontal within the GUI. Advantageously, the nature of the locus may be configurable by a user of the client.

Advantageously, the GUI is operative such that a user can cause the content of one or more cells to freeze. That is to say, cause the content of a cell to remain unchanging for a period of time. A user can freeze a cell in order that it is unaffected as changes in the market cause the content of the display to change. In preferred arrangement, freezing of a cell occurs as a result of a mouse pointer being moved into a predetermined part of the display, such as the cell itself or a region associated with the cell. For example, if the pointer is placed in the order region, the GUI may freeze only the cell containing the pointer or it may freeze all of the cells in the order region. Advantageously, the circumstances in which a cell becomes frozen can be configured by a user.

The GUI may be operative to unfreeze a frozen cell, such that its contents can once again be updated, in response to one or both of: the mouse being moved from an area that caused the cell to become frozen and a predetermined period of time has elapsed since the cell became frozen. Preferably, the circumstances in which a cell becomes unfrozen configurable by a user.

From a further aspect, this invention provides a method of operating a client for trading on an electronic exchange, the client having a graphical user interface (GUI) that includes:
a) displaying a price region comprising a plurality of cells arranged along a locus within each of which a price can be displayed;
b) displaying an order region adjacent to the price region, the order region having a plurality of cells within which order data can be displayed, each cell in the order region corresponding to a respective cell in the price region; and characterised by
c) displaying a current price indicator to indicate a fixed point on the locus;
d) and in that the display is updated by moving the content of the cells along the locus to maintain the current price of the market in place at the current price indicator.

From yet a further aspect, this invention provides a computer program product for execution on a client computer to perform a method according to the preceding aspect of the invention.

### BRIEF DESCRIPTION OF THE DRAWINGS

FIG. 1 is a generalised overview of an electronic market comprising a host computer and several trading client computers connected to it.

FIGS. 2 to 6 are screenshots of a display created by a graphical user interface (GUI) on a client embodying the invention, illustrating sequential progress through a trading operation;

FIGS. 7 and 8 show alternative indicating displays that show movement in prices in the market;

FIGS. 9 and 10 indicate alternative displays that are used to indicate that there is a spread in the market;

FIG. 11 illustrates scroll bars that can be used to select a price region that is not shown in the display;

FIG. 12 shows how multiple orders at the same price can be managed; and

FIGS. 13 and 14 show a GUI display being an alternative embodiment of the invention.

### DETAILLED DESCRIPTION OF THE PREFERRED EMBODIMENTS

Embodiments of the invention will now be described in detail, by way of example, and with reference to the accompanying drawings.

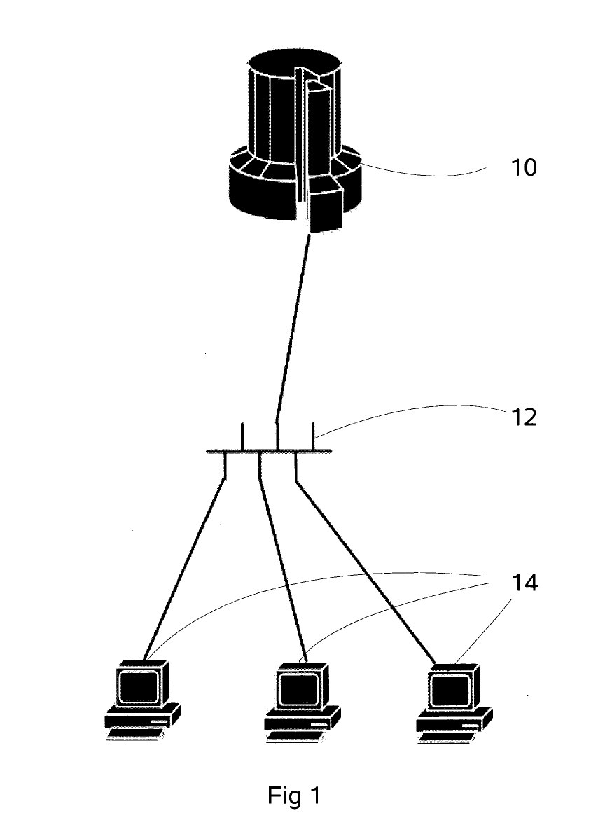

With reference first to FIG. 1, a typical electronic market can be represented as several computers connected in a network in a client/server arrangement.

The organisation running the market provides a server computer 10. This is connected over a network 12 to multiple client computers 14. The network can include many diverse components, some local-area and some wide-area, as required by the geographical distribution of the clients, and may, for example, include local-area Ethernet, long-distance leased lines and the Internet

In a typical case, the server is a high-powered computer or cluster of computers capable of handling substantially simultaneous requests from many clients. Each client is typically a considerably smaller computer, such as a single-user workstation. For the purposes of this illustrative embodiment, each client is a personal computer having a Java virtual machine running under the Microsoft Windows XP operating system

When a client 14 connects to the server 10, it is delivered over the network 12 a stream of data that represents the instantaneous state of the market. This data includes a description of all outstanding bids and asks, and of any trading activity within the market. The client 14 can also send a request over the network 12 to the server 10 to initiate a trading action. Typically, each client may be able to connect to several hosts to enable it to trade in several markets.

The above description is a simplification of an actual implementation of an electronic trading system. However, the components described are entirely familiar to those skilled in the technical field, as will the details of how they might be implemented in practice, so they will not be described here further.

Each client 14 executes a software program that allows a user to interact with the server 10 by creating a display that represents data received from the server 10 and sending requests to the server 10 in response to a user's input. In this embodiment, the software program is a Java program that executes within the virtual machine.

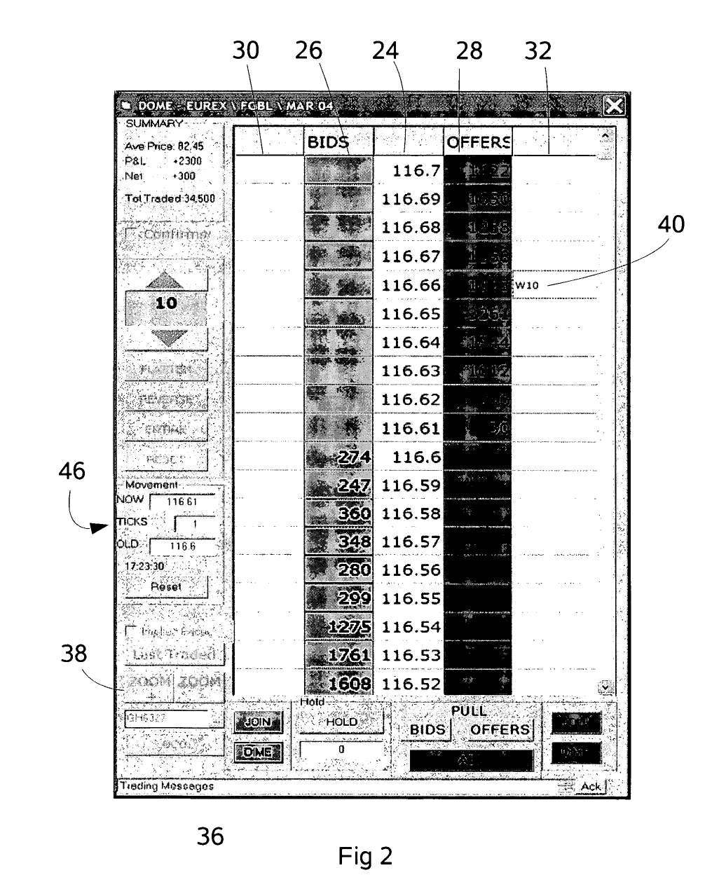

Amongst other elements, the display generated on the client includes a display of the depth of market. This display is illustrated in FIGS. 2 to 6. The main elements of the display will now be described.

The depth of market execution (DOME) display is contained within a single window 20. The window includes a prices panel 22 surrounded by associated controls. Many of the controls are provided in conventional trading screens. These perform functions such as selecting the number of units to be ordered with each trade, enabling a trader to pull all orders from the market, to join or dime a bid, present summary information, and so forth. Since these are well known, and are not directly connected to the invention, they will not be described further here.

The prices panel 22 includes five columns each containing a plurality of cells in which a number or other information can be displayed. The cells of the various columns are disposed in horizontal rows, such that each column has the same number of cells. The cells in the central of the five columns (the price column 24) contains a list of market prices, adjacent entries in the column being separated by a single market “tick” (the increment by which prices can vary within the market). To each side of the price column 24 is a respective volume column, the volume column to the left being a bid column 26 and the volume column to the right being an offer column 28. Adjacent to the bid column 26 is bid working column 30 and adjacent to the offer column is a offer working column 32. In this embodiment, the bid column 26 is coloured blue and the offer column is coloured 28 red. A central horizontal dividing line 34 extends across all five columns such that, for each column, an equal number of cells are disposed above and below the dividing line. The dividing line 34 therefore serves as a current price indicator. Thus, the Bid/Offer is locked into position. Prices move up or down in the price column 24, dynamically, around this fixed point. This movement takes place automatically and periodically during operation of the system.

While the trader positions his or her pointer to a part of the screen outwith the dome screen, the system operates in a normal mode in which the display is updated to present the trader with current market information.

At any one instant during normal operation, each cell in the bid column 26 contains a number indicative of the number of units for which traders in the market have placed bids at the price indicated in the adjacent cell of the price column 24. Likewise, each cell in the offer column 28 contains a number indicative of the number of units for which traders in the market have offered for sale at the price indicated in the adjacent cell of the price column 24. Cells in the bid and offer order columns 30, 32 contain an indication of the number of units that the trader who is using the client has in the market at the price indicated in the corresponding cell of the price column 24.

An important control provided on the display is the zoom control 38. The zoom control allows a user to increase the height of the cells but show fewer rows (zoom in), or increase the number of rows by decreasing the height of the cells.

In order to trade in the market, the trader places the mouse pointer in the bid or offer column, as appropriate, in the cell next to that cell in the price column 24 that contains the price at which they wish to place an order. The action of clicking in a cell of one of these two columns may either initiate an order or cause a dialogue box to appear, the order only then being placed if the trader gives confirmation.

When a trader has a bids or an offer order in the market, these are indicated in the appropriate offer column in a cell that occupies the row corresponding to the price at which the trade was made. The trader can click in the cell corresponding to one of their previous orders to amend or withdraw it.

The display is updated automatically periodically or in response to changes in the market such that the last bid price in the market appears in the row immediately below the dividing line 34 and the last offer price appears in the row immediately above the dividing line 34. This happens without the requirement for any user input. As the bid and offer prices change, the figures in the prices column 24 are moved upwards or downwards to ensure that the relation between the prices and the dividing line 34 is maintained. During normal operation, the contents of the order columns also move upwards and downwards in synchronism with the contents of the price column 24.

As will be appreciated, in a rapidly changing market, the contents of the column will be changing rapidly. This would make it difficult for a trader to accurately target the correct cell with his or her mouse pointer. Therefore, this embodiment provides functionality that overcomes this problem.

When a mouse pointer is moved over any column other than the price column, part of the column is “frozen”. In a typical configuration, movement of the pointer into either of the bid or offer columns 26, 28 causes the cell into which the pointer has moved to freeze. While frozen, the contents of a cell are not changed, even if the contents of other cells in the DOME display are shifted up or down. If the mouse pointer is place in an offer column 30, 32, the entire contents of the column are frozen.

In this embodiment, the action that takes place when the mouse is moved into a column can be configured by the trader. In the case of each column (apart from the price column) the trader can select from three options: take no action, freeze the cell, freeze the column. In addition, the GUI may include a toggle button 36 that can be used by the trader to turn on or off the freezing functionality.

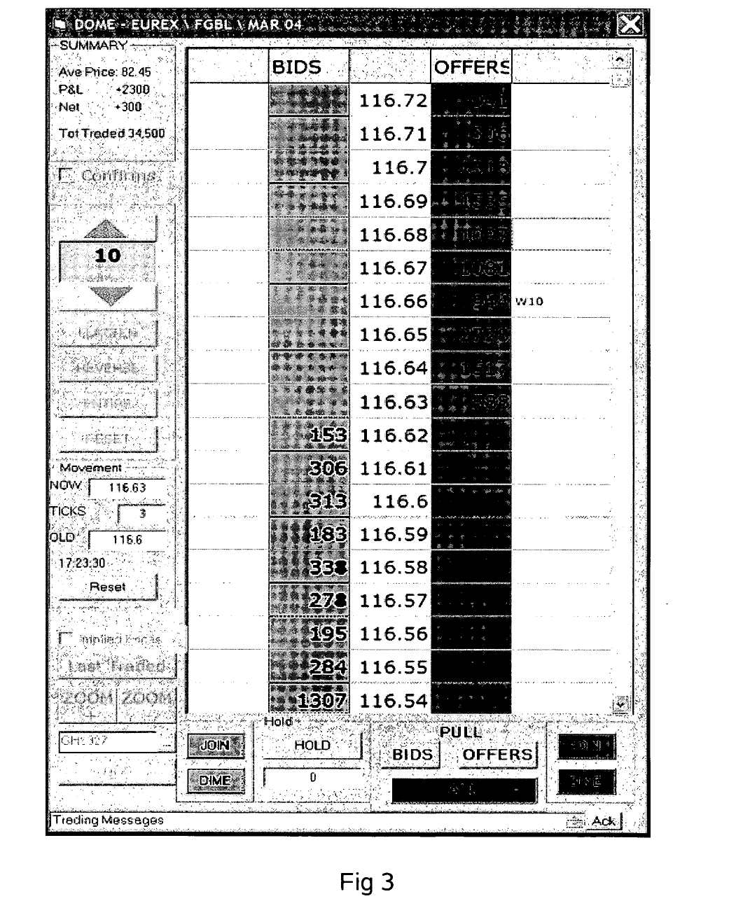

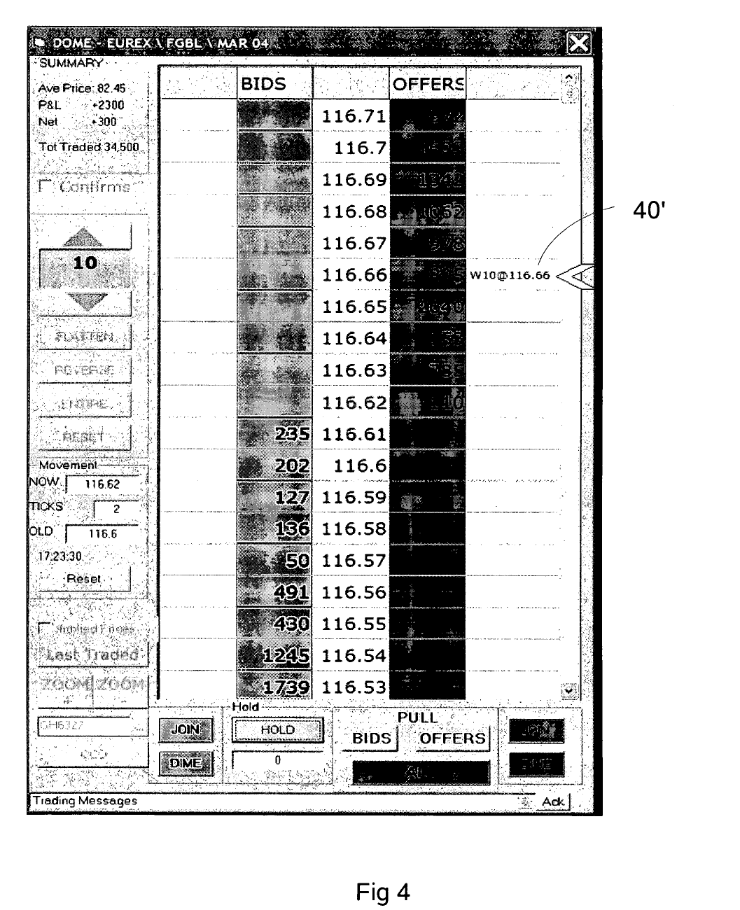

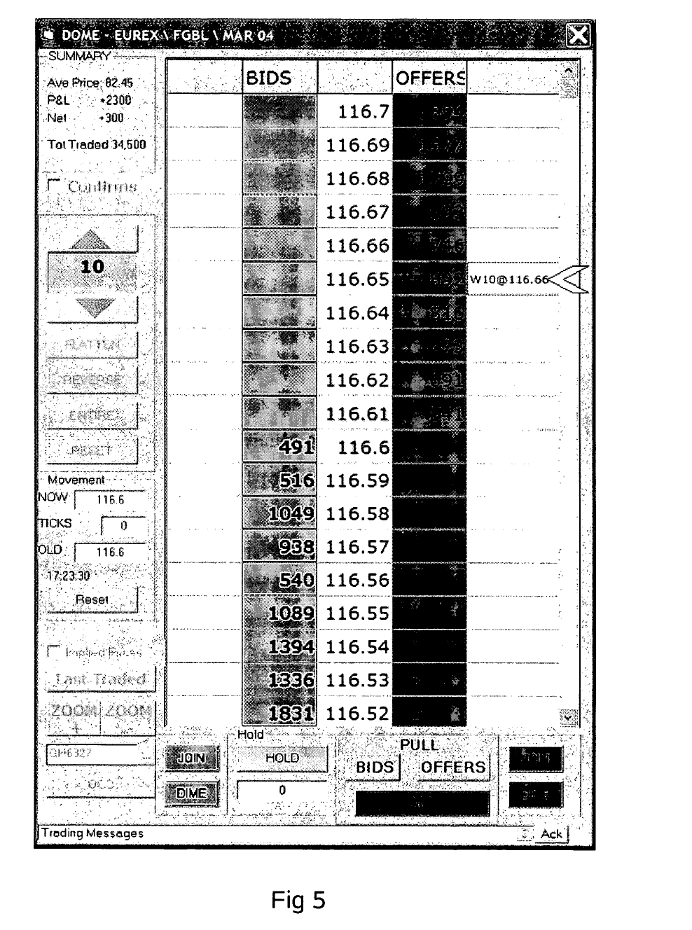

It will be understood that a cell that is frozen (whether individually or part of a column) may become displaced from the entry in the price column 24 if the price changes while it is frozen. This has the potential to cause confusion—the trader could easily forget the price to which the order relates. Therefore, in this embodiment, the content of any cell that has been frozen is updated so as to include both an order quantity and the associated price. An example of this can be seen by comparing FIGS. 3, 4 and 5. In FIG. 3, shown at 40, is an example of an offer order of 10. Because the cell is not frozen, it is possible to tell that the order price is 116.66 simply by reading the associated cell in the price column. In comparison, FIG. 4 shows the cell immediately after it has been frozen. The content of the cell (shown at 40′) has been changed to include both the quantity and the price. At the instant the screenshot of FIG. 4 was taken, there had been no change in the market price following the freezing of the cell. The screenshot of FIG. 5 illustrates the display after the market price has moved. The cell in the price column 24 next to the frozen cell now reads 166.65, so it no longer corresponds to the price of the order in the frozen cell. It is therefore necessary to refer to the updated cell contents to determine the price of the order.

Un-freezing can occur in two circumstances that can be selected by the user. First, it may be as a result of the user moving the mouse pointer out of the column of cell that is frozen. Alternatively, it can happen a predetermined time after the cell is frozen.

Use of a DOME screen embodying the invention will now be described.

With reference first to FIG. 2, a working Sell order of 10 lots at a price of 116.66 is entered into the market by clicking on the offer column 28 in the cell adjacent to the price 116.66, which appears in the centre price column 24.

In FIG. 3, the market has moved from 116.60/61 to 116.62/63. The working order is always in the working column cell adjacent to the price it is working at 116.66.

In FIG. 4, the market has moved from 116.62/63 to 116.61/62. Freeze/Hold functionality is turned on. The working order has its price (116.66) added to the cell displaying the working order when the mouse pointer is over the offer-working column. This cell is now frozen in position.

In FIG. 5, the market has moved from 116.61/62 to 116.60/61. The frozen cell has not moved with the market movement (unlike in FIG. 3) and the working order (in the offer working column 32) is no longer adjacent to the price displayed in the dynamic price ladder 24.

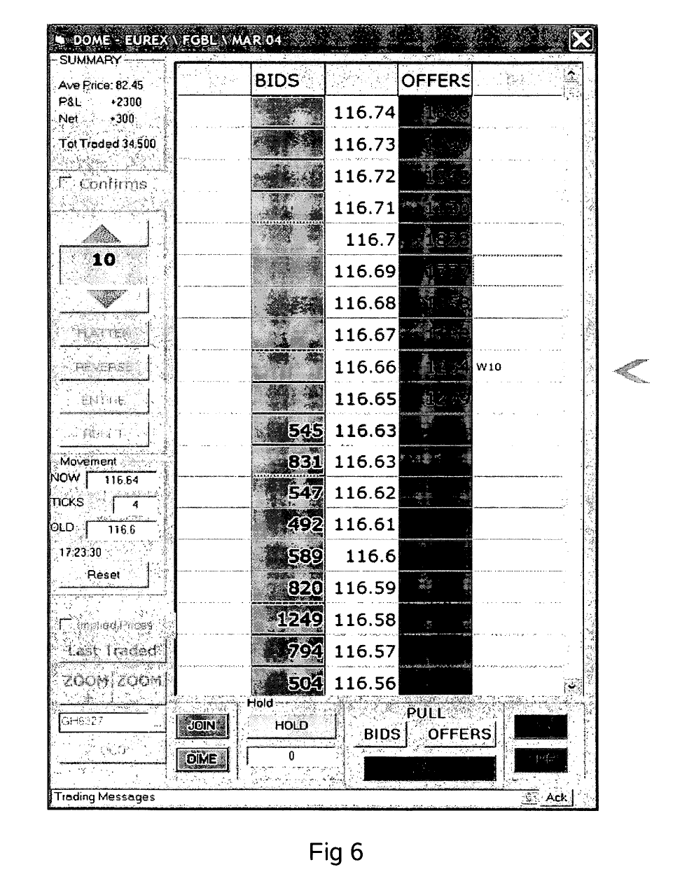

In FIG. 6, the market has moved from 116.60/61 to 116.63/65. The trader has moved the mouse pointer off the cell containing the working order. The working order moves to the cell that is adjacent to its working price in the market (116.66).

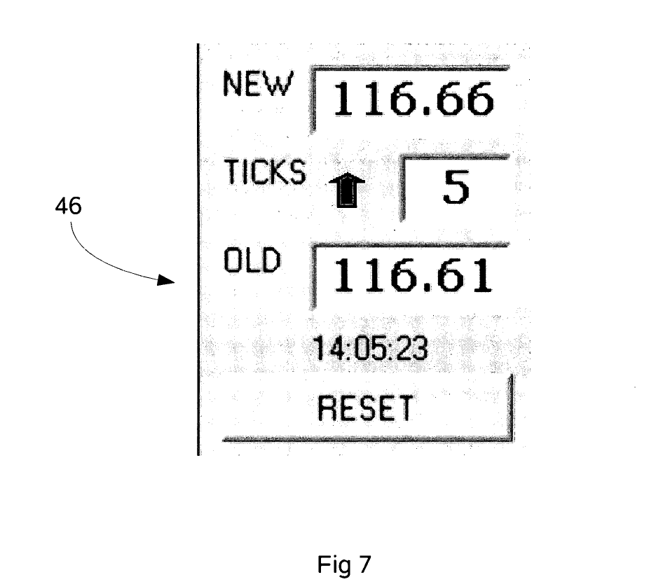

In order to assist a trader's understanding of price movement within the market additional display objects may be provided. In this embodiment, this is achieved by providing a “movement panel” 46 in the DOME display, which is shown in more detail in FIG. 7. The GUI software allows the user to decide whether or not the movement panel is actually displayed.

The fields contained within the movement panel 46 are as follows. The “NEW” price indicates the current market Last Traded Price (LTP). “OLD” indicates the LTP, at the time of the last movement panel reset (with a timestamp). TICK (price increments) shows the distance between the two in tick units. An upwardly or downwardly pointing arrow indicates the direction of movement. The movement panel 46 can be reset using a command button or by a pre-configured rule. Examples of such rules might be either after every predetermined number of tick movements. At the option of the user, the movement panel will highlight for a user-defined period (e.g. 1 second) before changing.

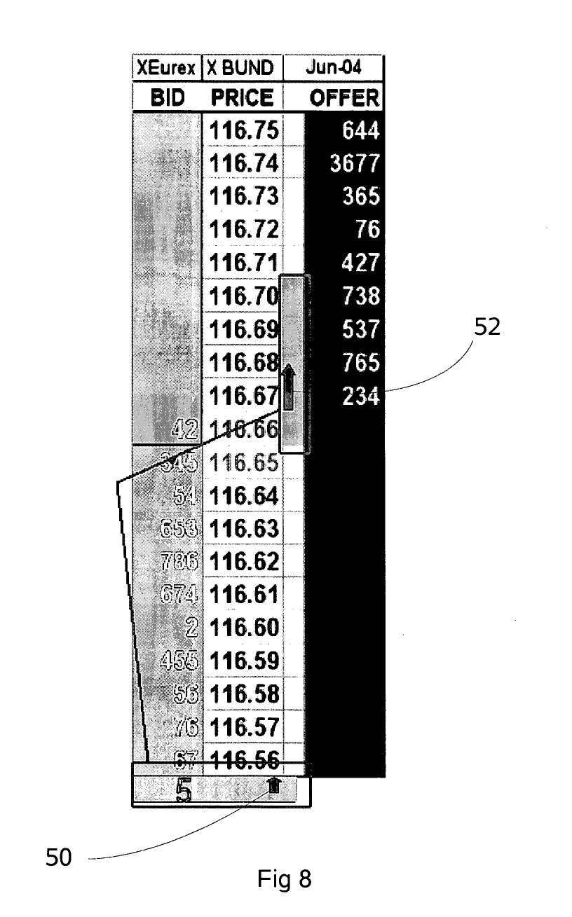

As an alternative to the movement panel, a movement bar may be provided, as shown in FIG. 8. A movement bar is a graphical element in the form of vertical or horizontal bar 50, 52 with a direction arrow to indicate the direction of market movement and a numerical label to indicate the size of movement (in ticks). Thus, the length of the bar indicates how far the market has moved. The bar can be reset using a command button or pre-configured rule. The rule might, for example, be either every predetermined number of tick movements or when the bar is a predetermined distance (measured in ticks) from the end of the screen.

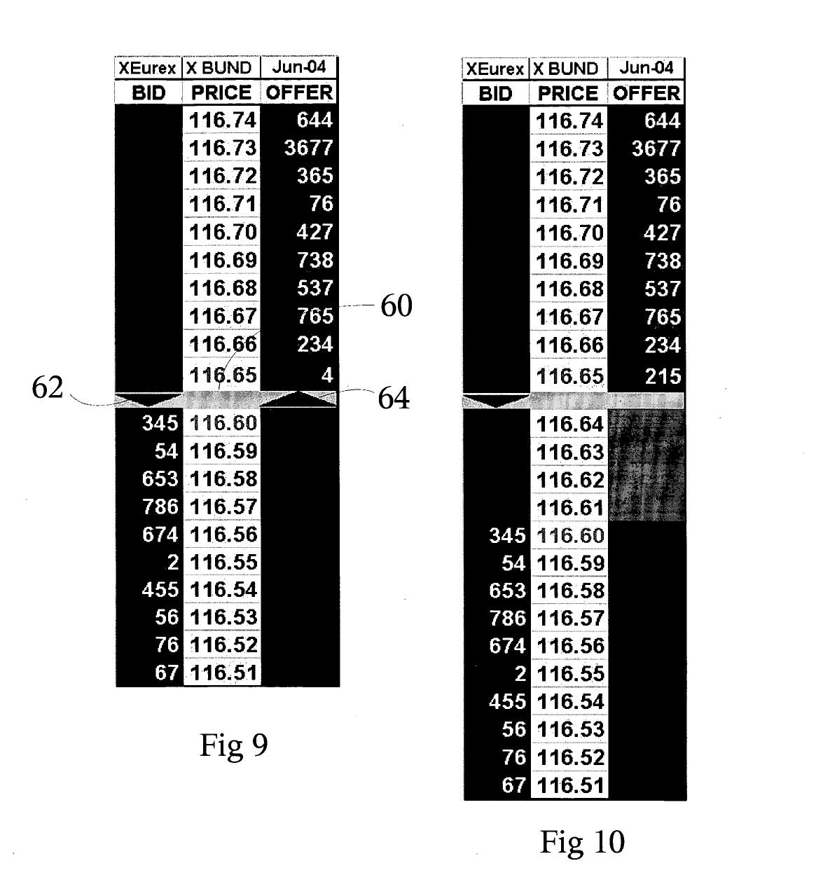

A display as shown in FIG. 9 is used to indicate that there is a spread in the market—a gap between the highest bid price and the lowest offer price. A grey bar 60 is displayed between the bid and the offer, the bar 60 containing two directional arrows, the arrow 62 in the bid column being coloured blue and the arrow 64 in the offer column being coloured red. Clicking on one of the arrows 62, 64 expands the grid downwards or upwards to display the extra rows which will hold the inside market prices. These prices are calculated dynamically relative to the bid/offer price. Clicking on the arrow again turns this gap off. If the bid and offer move to only one tick apart then the grey bar 60 will disappear. FIG. 10 shows this new display after the blue arrow 62 has been clicked.

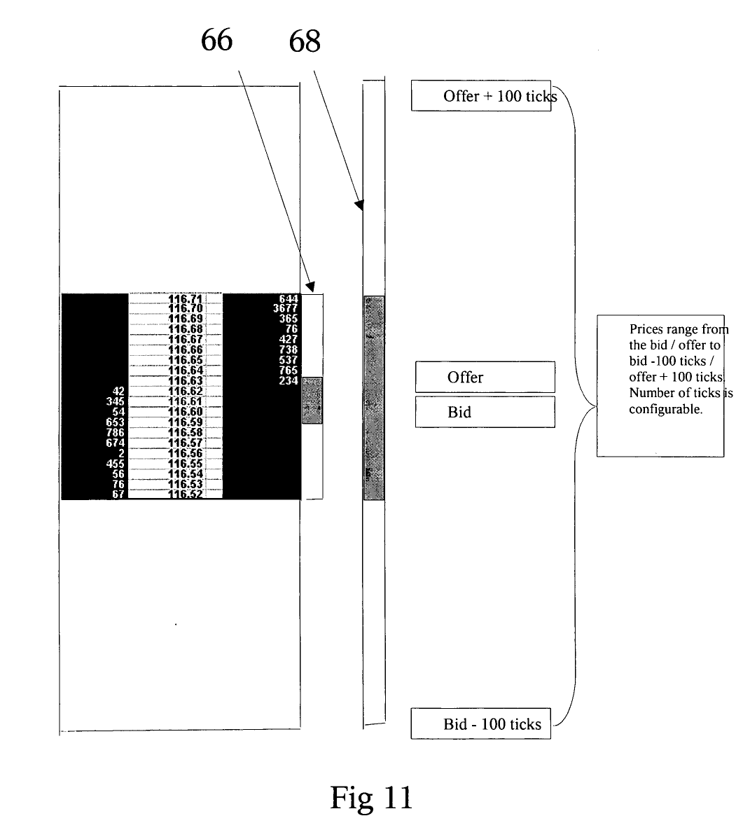

The display is capable of displaying only a finite range of prices. As an enhancement to this embodiment, two scroll bars may be provided within the DOME, one for the bids and one for the offers. These allow a trader to scroll the display to show any price required. The scroll bars are included to allow a trader to enter orders above or below the market when the trader chooses not to use the zoom functionality. These are illustrated in FIG. 11. The software allows the size of the scroll bar can be determined by the trader. For example, with 10 bids visible in the DOME and a scroll setting of 100 ticks or price increments (0.01), it is possible for the trader to scroll from the current bid (e.g. 100.00) to a price 100 ticks or price increments below (e.g. 99.00). In FIG. 11, the scroll bar 66 is a scaled version of scroll bar 68. By moving scroll bar 68, the trader can move to any price required along the dynamic price ladder. Alternatively, a command button may be provided that, when activated, allows a trader to specify a price value and the display will then scroll to display that value.

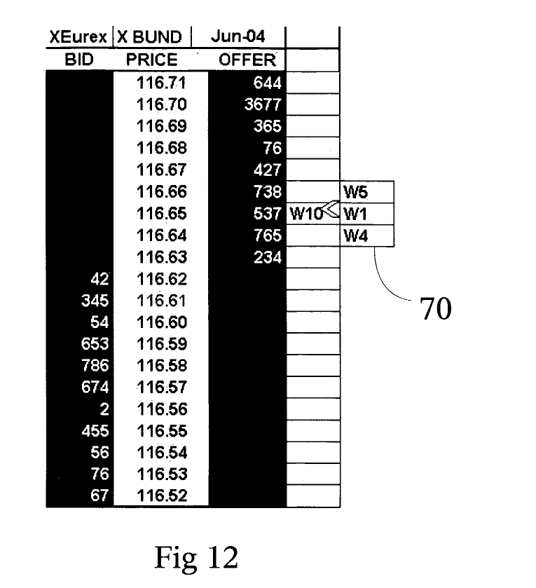

A trader may place multiple orders at a single price. In some circumstances, it may be appropriate to display these as a single order for the total number of units, or as multiple smaller orders. For the later case, the trader turns on ‘multiple amend’ functionality. In this mode, a “mouse-over” event in the working column creates a side window 70 that allows the trader to modify each order individually, as shown in FIG. 12.

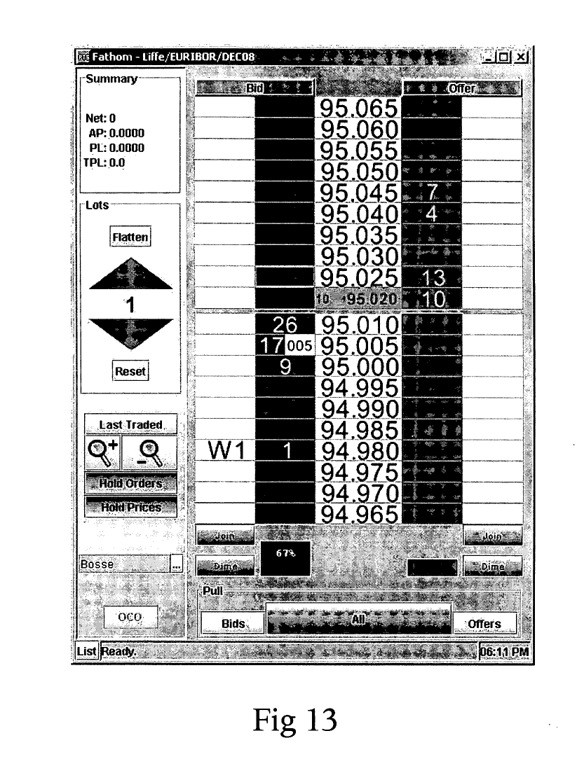

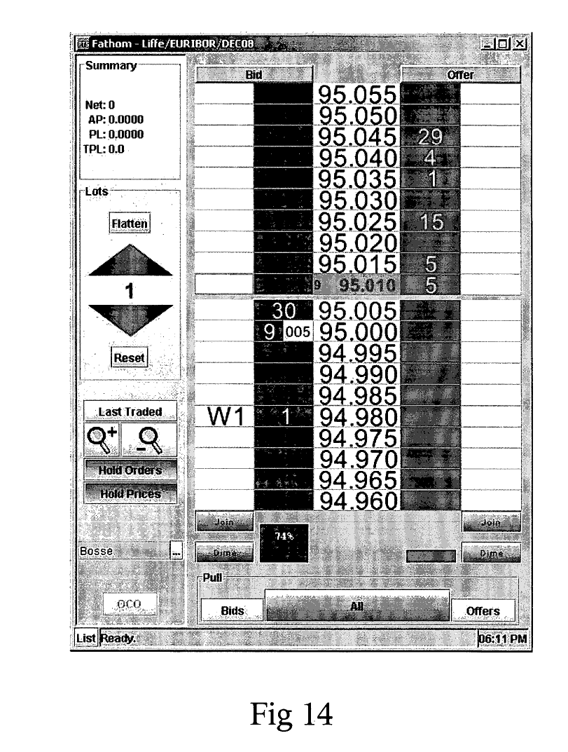

FIGS. 13 and 14 show a display generated by an alternative embodiment of the invention. In FIG. 13, the mouse has moved over the bid column adjacent the cell at 95.005, and the content of the cell has changed to illustrate the frozen price (abbreviated to “005”) and the amount in the market (17). FIG. 14 is a screen capture taken after the price has moved. The display in this screenshot also includes separate hold buttons for volume and order status columns. A trader can decide which part of the price to capture, including, for example, ticks only, full price, or a custom definition based on number of decimal places before and after decimal point.

A summary list of features that can be included in embodiments of the invention is presented below.

The display uses dynamic price movement, anchored around a mid-point between the bid (in blue) and the offer (in red) where a ‘spread’ between the bid and the offer always exists in the market. The display further includes indicators of:
Last Traded (LT) volume
LT direction arrow e.g. ‘up’ for an upward market movement & vice versa
Prices can be displayed either horizontally or vertically
Prices are always in ascending/descending numerical order
Prices are always in a single line
High and Low (traded price) of the day is indicated visually
Two working columns (the outside columns of DOME screen) provide:
Working, held and filled orders are visible
Freeze/Hold functionality (for either a set period of time e.g. 1 second or indefinitely, according to user preference). When functionality is active a ‘mouse-over event’ will freeze the cell contents that the mouse is over. A cell will also change to display additional relevant information (either working order(s) at price or other information for the trader to make a trade decision, for as long as the mouse-over event lasts or for a previously configured period of time). This includes changing the colours of the cell, to highlight that it is frozen. Mouse-over of either an individual cell or the column will trigger the freeze.
Pull functionality (remove order from market).
Pull order at corresponding price (by mouse click).
   .i) Pull selected order from corresponding price with multiple orders (by mouse click
   .ii) Pull multiple working orders at corresponding price (by mouse click)
Amend functionality (amend working or held order)
   .i) Amend price of order (one-click ‘drag & drop’ to new price). During these operations, the mouse pointer may be changed to display information relevant to the trader, e.g. price, volume, and so forth.
   .ii) Amend account number of working order
   .iii) Amend volume of working order
Two volume columns showing dynamic bids/offers headed ‘XEurex’ & ‘Jun04’ in the figures.
Freeze/Hold functionality (for either a set period of time e.g. 1 second or indefinitely). When functionality is active a ‘mouse-over event’ will ‘freeze’ the contents of the cell that the mouse is on. Cell will change to display relevant information (either price, a pre-defined volume or the bid/offer at price when window froze). Either the individual cell or the entire column can trigger the ‘mouse over’ event. Buy side items are labelled as PRICE for VOLUME while sell side items are displayed as VOLUME at PRICE (following market convention).
Bids/Offers can be colour coded
Buy (Bids)/Sell (Offers) Order entry regions—defined by the user
By area clicked per user interface (e.g. mouse button1, mouse button2, etc)
   .i) Buy/Sell
   .ii) Order type (exchange supported or available synthetically)
   .iii) Lots as defined in the (Volume definition area).

Throughout the description of the embodiment, user interaction with the GUI has been described as through use of a mouse or similar pointing device to initiate actions. Alternative or additional input means may be used, such as through use of a keyboard, a touch screen, or from another application.

Microsoft and Windows are registered trade marks of Microsoft Corporation.

Java is a registered trade mark of Sun Microsystems.

What is claimed is:

1. A client for trading on an electronic exchange, the client having a graphical user interface (GUI) that includes:
a) a price region comprising a plurality of cells arranged along a locus within each of which a price can be displayed;
b) an order region adjacent to the price region, the order region having a plurality of cells within which order data can be displayed, each cell in the order region corresponding to a respective cell in the price region; and characterised by
c) a current price indicator that indicates a fixed point on the locus;
d) and in that the display is updated by moving the content of the cells along the locus to maintain the current price of the market in place at the current price indicator.

2. A client for trading on an electronic exchange according to claim 1 in which the locus is a straight line.

3. A client for trading on an electronic exchange according to claim 2 in which the locus is either vertical or horizontal within the GUI.

4. A client for trading on an electronic exchange according to claim 1 in which the nature of the locus is configurable by a user of the client.

5. A client for trading on an electronic exchange according to claim 1 in which the GUI is operative such that a user can cause the content of one or more cells to freeze.

6. A client for trading on an electronic exchange according to claim 5 in which freezing of a cell occurs as a result of a mouse pointer being moved into a predetermined part of the display.

7. A client for trading on an electronic exchange according to claim 6 in which the predetermined part of the display is the cell itself.

8. A client for trading on an electronic exchange according to claim 6 in which the predetermined part of the display is a region associated with the cell.

9. A client for trading on an electronic exchange according to claim 8 in which the predetermined part of the display is the order region and placing the pointer in the order region freezes all of the cells in the order region.

10. A client for trading on an electronic exchange according to claim 5 in which circumstances in which freezing of a cell occurs is configurable by a user.

11. A client for trading on an electronic exchange according to claim 5 in which the GUI is operative to unfreeze a frozen cell in response to one or both of: the mouse being moved from an area that caused the cell to become frozen and a predetermined period of time has elapsed since the cell became frozen.

12. A client for trading on an electronic exchange according to claim 11 in which the circumstances in which a cell becomes unfrozen configurable by a user.

13. A client for trading on an electronic exchange according to claim 1 in which the display is updated periodically without requiring an action from a user.

14. A client for trading on an electronic exchange according to claim 1 in which the display is updated in response to changes in the market without requiring an action from a user.

15. A method of operating a client for trading on an electronic exchange, the client having a graphical user interface (GUI) that includes:
a) displaying a price region comprising a plurality of cells arranged along a locus within each of which a price can be displayed;
b) displaying an order region adjacent to the price region, the order region having a plurality of cells within which order data can be displayed, each cell in the order region corresponding to a respective cell in the price region; and characterised by
c) displaying a current price indicator to indicate a fixed point on the locus;
d) and in that the display is updated by moving the content of the cells along the locus to maintain the current price of the market in place at the current price indicator.

16. A method according to claim 15 in which the locus is a straight line.

17. A method according to claim 16 in which the locus is either vertical or horizontal within the GUI.

18. A method according to claim 15 in which the nature of the locus is configurable by 20 a user of the client.

19. A method according to claim 15 in which the GUI operates such that a user can cause the content of one or more cells to freeze.

20. A method according to claim 19 in which freezing of a cell occurs as a result of a mouse pointer being moved into a predetermined part of the display.

21. A method according to claim 20 in which the predetermined part of the display is the cell itself.

22. A method according to claim 20 in which the predetermined part of the display is a region associated with the cell.

23. A method according to claim 22 in which the predetermined part of the display is the order region and placing the pointer in the order region freezes all of the cells in the order region.

24. A method according to claim 20 in which circumstances in which freezing of a cell occurs is configurable by a user.

25. A method according to claim 20 in which the GUI unfreezes a frozen cell in response to one or both of: the mouse being moved from an area that caused the cell to become frozen and a predetermined period of time has elapsed since the cell became frozen.

26. A method according to claim 25 in which the circumstances in which a cell becomes unfrozen configurable by a user.

27. A method according to claim 15 in which the display is updated periodically without requiring an action from a user.

28. A method according to claim 15 in which the display is updated in response to changes in the market without requiring an action from a user.

29. A computer program product for execution on a client computer to perform a method according to claim 15.
